(19) United States
(12) Patent Application Publication
(10) Pub. No.: US 2024/0327705 A1
(43) Pub. Date: Oct. 3, 2024

(54) ZINC-DOPED QUANTUM DOT AND MANUFACTURING METHOD THEREFOR

(71) Applicants: RESEARCH & BUSINESS FOUNDATION SUNGKYUNKWAN UNIVERSITY, Suwon-si (KR); SOGANG UNIVERSITY RESEARCH AND BUSINESS FOUNDATION, Seoul (KR)

(72) Inventors: Sohee JEONG, Suwon-si (KR); Moon Sung KANG, Seoul (KR); Hyoin KIM, Suwon-si (KR); Daekwon SHIN, Suwon-si (KR); Jong Il YOON, Seoul (KR); Hyun Woo JO, Seoul (KR)

(73) Assignees: RESEARCH & BUSINESS FOUNDATION SUNGKYUNKWAN UNIVERSITY, Suwon-si (KR); SOGANG UNIVERSITY RESEARCH AND BUSINESS FOUNDATION, Seoul (KR)

(21) Appl. No.: 18/743,654

(22) Filed: Jun. 14, 2024

Related U.S. Application Data
(63) Continuation of application No. PCT/KR2022/019691, filed on Dec. 6, 2022.

(30) Foreign Application Priority Data
Dec. 14, 2021 (KR) 10-2021-0178597

(51) Int. Cl. C09K 11/54

(52) U.S. Cl. CPC C09K 11/54

(57) ABSTRACT

The present invention relates to a quantum dot comprising: a core bearing III-V group compounds; and a ligand formed on the core, wherein the core is doped with zinc (Zn).

### CROSS-REFERENCE TO RELATED APPLICATION

This application is a by-pass continuation of International Application No. PCT/KR2022/019691, filed on Dec. 6, 2022 in the Korean Intellectual Property Receiving Office, which is based on and claims priority to Korean Application No. 10-2021-0178597, filed on Dec. 14, 2021 in the Korean Intellectual Property Office, the entire disclosures of which are incorporated herein by reference.

### TECHNICAL FIELD

The present application relates to a zinc-doped quantum dot and a method for preparing the same.

### BACKGROUND ART

A quantum dot is a semiconductor material having a size of several nm, and shows unique properties different from bulk materials due to a quantum confinement effect by small sizes. Due to these properties, quantum dots are applied to and studied in various fields such as an optoelectronic device, etc., as next-generation materials. However, quantum dots still have limitations in their application despite their various advantages. First, II-VI and IV-VI quantum dots, which have been studied a lot, cause environmental problems because of containing toxic heavy metals such as Cd, Pb, etc., and thus find difficulty in commercialization. InAs quantum dots are free from the above-described problems because of containing elements with relatively low toxicity, and are promising materials for near-infrared elements because of absorbing and emitting light in a near-infrared region.

However, in order to apply quantum dots as semiconductor materials, electrical properties need to be excellent, and a technology of controlling the electrical properties is also important. Although many studies have been conducted to improve the electrical properties of quantum dots, unlike bulk semiconductors used in industry, quantum dots have a problem that it is difficult to freely control the n-type and p-type properties. According to several papers, InAs is also reported to have n-type properties, but InAs quantum dots exhibiting p-type properties per se have not yet been reported. The development of p-type InAs quantum dots may be seen as an essential process because n-type and p-type properties need to be controlled so that quantum dots may be applied as a semiconductor material.

Several papers have been reported on doping of InAs quantum dots, among which it has been reported that electrical properties are changed through subsequent processing using Cu and Cd. A post-treatment process during the doping of quantum dots means that the synthesis of quantum dots and the injection of a dopant are performed in separate steps. In the related art, doping was performed on the InAs by using CuCl₂ and Cd(oleate)₂.

Interstitial doping of Cu is performed in the form of introducing a dopant between crystal lattices. Cu is introduced between InAs quantum dot lattices and provides additional electrons to act as an n-dopant. Cd is doped into the InAs quantum dots through substitutional doping. Unlike In providing three electrons, Cd provides two electrons, and thus acts as a p-dopant by providing one hole. The InAs quantum dot, which was n-type, has been strengthened in n-type properties by Cu and has changed into p-type by Cd. This has been a meaningful result that p-type InAs quantum dots may be obtained through Cd doping, but doping is performed through a subsequent treatment process, and thus it is somewhat complicated, and a toxic heavy metal called Cd is used, thus causing environmental problems.

Thus, there is a need to develop a p-type quantum dot material which uses a material having low toxicity and does not require a subsequent treatment process.

Korean Unexamined Patent Application No. 10-2018-0108012, which is a background technology of the present application, relates to quantum dots doped with a transition metal and a method for preparing the same. Although the above patent describes the use of a transition metal as a dopant to exhibit only a quantum confinement effect and increase quantum efficiency without changing a wavelength band of quantum dots, the patent does not describe a p-type quantum dot material using a material having low toxicity and not requiring a subsequent treatment process.

### DISCLOSURE

### Technical Problem

To solve the aforementioned problems of the related art, an object of the present application is to provide a quantum dot having p-type semiconductor properties doped with zinc, which is a low toxic material.

In addition, an object of the present application is to provide a method for preparing the quantum dot.

Furthermore, an object of the present application is to provide an electronic element including the quantum dot.

However, the technical problems to be achieved by the embodiments of the present application are not limited to the technical problems described above, and other technical problems may exist.

### Technical Problem

As a technical solution for achieving the above technical objects, a first aspect of the present application may provide a quantum dot including: a core bearing III-V group compounds; and a ligand formed on the core, in which the core is doped with zinc (Zn).

According to one embodiment of the present application, the quantum dot may have p-type semiconductor properties, but is not limited thereto.

According to one embodiment of the present application, the III-V group compounds may be selected from the group consisting of indium arsenide (InAs), indium phosphorus (InP), indium antimony (InSb), indium nitride (InN), gallium phosphorus (GaP), gallium arsenide (GaAs), gallium antimony (GaSb), gallium nitride (GaN), aluminum phosphorus (AlP), aluminum arsenide (AlAs), aluminum antimony (AlSb), aluminum nitride (AlN), gallium phosphorus arsenide (GaPAs), gallium phosphorus antimony (GaPSb), gallium phosphorus nitride (GaPN), gallium arsenide nitride (GaAsN), gallium antimony nitride (GaSbN), aluminum phosphorus arsenide (AlPAs), aluminum phosphorus antimony (AlPSb), aluminum phosphorus nitride (AlPN), aluminum arsenide nitride (AlAsN), aluminum antimony nitride (AlSbN), indium phosphorus arsenide (InPAs), indium phosphorus antimony (InPSb), indium phosphorus nitride (InPN), indium arsenide nitride (InAsN), indium antimony nitride (InSbN), aluminum gallium phosphorus (AlGaP), aluminum gallium arsenide (AlGaAs), aluminum gallium antimony (AlGaSb), aluminum gallium nitride (AlGaN), aluminum arsenide nitride (AlAsN), aluminum antimony nitride (AlSbN), indium gallium phosphorus (InGaP), indium gallium arsenide (InGaAs), indium gallium antimony (InGaSb), indium gallium nitride (InGaN), indium arsenide nitride (InAsN), indium antimony nitride (InSbN), aluminum indium phosphorus (AlInP), aluminum indium arsenide (AlInAs), aluminum indium antimony (AlInSb), aluminum indium nitride (AlInN), aluminum arsenide nitride (AlAsN), aluminum antimony nitride (AlSbN), aluminum phosphorus nitride (AlPN), gallium aluminum phosphorus arsenide (GaAlPAs), gallium aluminum phosphorus antimony (GaAlPSb), gallium indium phosphorus arsenide (GaInPAs), gallium indium aluminum arsenide (GaInAlAs), gallium aluminum phosphorus nitride (GaAlPN), gallium aluminum arsenide nitride (GaAlAsN), gallium aluminum antimony nitride (GaAlSbN), gallium indium phosphorus nitride (GaInPN), gallium indium arsenide nitride (GaInAsN), gallium indium aluminum nitride (GaInAlN), gallium antimony phosphorus nitride (GaSbPN), gallium arsenide phosphorus nitride (GaAsPN), gallium arsenide antimony nitride (GaAsSbN), gallium indium phosphorus antimony (GaInPSb), gallium indium phosphorus nitride (GaInPN), gallium indium antimony nitride (GaInSbN), gallium phosphorus antimony nitride (GaPSbN), indium aluminum phosphorus arsenide (InAlPAs), indium aluminum phosphorus nitride (InAlPN), indium phosphorus arsenide nitride (InPAsN), indium aluminum antimony nitride (InAlSbN), indium phosphorus antimony nitride (InPSbN), indium arsenide antimony nitride (InAsSbN), indium aluminum phosphorus antimony (InAlPSb), and combinations thereof, but are not limited thereto.

According to one embodiment of the present application, the ligand may be selected from the group consisting of oleylamine, butylamine, octylamine, dodecylamine, hexadecylamine, hexylamine, propylamine, aniline, benzylamine, octadecylamine, and combinations thereof, but is not limited thereto.

According to one embodiment of the present application, a diameter of the quantum dot may be 1 nm to 9.5 nm, but is not limited thereto.

In addition, a second aspect of the present application may provide a method for preparing a quantum dot, the method comprising: preparing a solution containing a III group precursor and a solvent; reducing a V group precursor by using a compound containing zinc (Zn); and preparing III-V group compounds by mixing the solution and the reduced V group precursor, in which the zinc (Zn) is doped into the III-V group compounds.

According to one embodiment of the present application, the mixing may be performed in a temperature range of 1 to 350° C., but is not limited thereto.

According to one embodiment of the present application, a diameter of the quantum dot may be adjusted depending on the temperature range, but is not limited thereto.

According to one embodiment of the present application, an III group element of the III group precursor may be selected from the group consisting of indium, aluminum, gallium, and combinations thereof, but is not limited thereto.

According to one embodiment of the present application, the III group precursor may be selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium oxide, gallium iodide, triethyl gallium, trimethyl gallium, and combinations thereof, but is not limited thereto.

According to one embodiment of the present application, the solvent may be selected from the group consisting of oleylamine, butylamine, octylamine, dodecylamine, hexadecylamine, hexylamine, propylamine, aniline, benzylamine, octadecylamine, and combinations thereof, but is not limited thereto.

According to one embodiment of the present application, the compound containing zinc (Zn) may be selected from the group consisting of diethyl zinc, dimethyl zinc, diphenyl zinc, di-n-propyl zinc, di-n-butyl zinc, diisobutyl zinc, di-n-pentyl zinc, di-n-hexyl zinc, dicyclohexyl zinc, and combinations thereof, but is not limited thereto.

According to one embodiment of the present application, a V group element of the V group precursor may be selected from the group consisting of arsenic (As), nitrogen (N), phosphorus (P), and combinations thereof, but is not limited thereto.

According to one embodiment of the present application, the V group precursor may be selected from the group consisting of dimethylaminoarsine, arsenic oxide, arsenic chloride, arsenic sulfate, arsenic bromide, arsenic iodide, tristrimethylsilylarsenide, arsenic trioxide, arsenic silylamide, alkyl phosphine, tristrialkylsilyl phosphine, phosphine, trisdialkylamino phosphine, nitric oxide, nitric acid, ammonium nitrate, and combinations thereof, but is not limited thereto.

According to one embodiment of the present application, a ratio of Zn to the III group precursor may be controlled, but is not limited thereto.

According to one embodiment of the present application, a ratio of Zn to the III group precursor may be greatly controlled, thus resulting in p-type semiconductor properties, but is not limited thereto.

In addition, the present application may provide a quantum dot including III-V group compounds, in which the quantum dot has a 2 theta peak of 25.5 or more to 26.5 or less in x-ray diffraction (XRD).

According to one embodiment of the present application, the peak may have a (111) crystal orientation, but is not limited thereto.

According to one embodiment of the present application, it may have a binding energy peak of 1,020 or more to 1,030 or less and 1,040 or more to 1,050 or less in x-ray photoelectron spectroscopy (XPS).

In addition, a third aspect of the present application may provide an electronic element including a quantum dot according to a first aspect of the present application.

The above-described technical solutions are set forth to illustrate only and should not be construed as intended to limit the present disclosure. In addition to the exemplary embodiments described above, additional embodiments may exist in the drawings and detailed description of the invention.

### Advantageous Effects

While the conventional p-type quantum dots have a disadvantage of causing an environmental problem because of using Cd, which is a toxic material, the quantum dots according to the present application can be p-type quantum dots prepared by using Zn, which is not toxic, thus causing no environmental problem.

In addition, unlike the related art in which the p-type quantum dots are prepared through a rather complicated process because doping is performed through a post-treatment process, the quantum dots according to the present application can have an advantage of being simply prepared through a single synthesis without a post-treatment process.

In addition, in the quantum dots according to the present application, a doping degree of the quantum dots can be controlled according to a content of Zn, and thus a Fermi level and a hole density can be controlled.

However, the effects obtainable herein are not limited to the effects described above, and other effects may also exist.

### DESCRIPTION OF DRAWINGS

FIG. 1A shows a schematic view of a conventional interstitial-doped quantum dot, and

FIG. 1B shows a schematic view of a conventional substitutional-doped quantum dot.

FIG. 2 shows a schematic view of p-type doping of a quantum dot according to one embodiment of the present application.

FIG. 3 shows a schematic view of a quantum dot according to one embodiment of the present application.

FIG. 4 shows a flow chart of a method for preparing a quantum dot according to one embodiment of the present application.

FIG. 5 shows a graph obtained by measuring element properties of TFT including a quantum dot according to one example of the present application.

FIG. 6 shows a current-voltage curve of TFT including quantum dots according to Experimental Examples 1 to 3 of the present application, respectively.

FIG. 7 shows a result of x-ray photoelectron spectroscopy (XPS) measurement of a quantum dot according to an example of the present application.

FIG. 8 shows a result of x-ray diffraction (XRD) measurement of a quantum dot according to an example of the present application and a conventional quantum dot.

### MODE FOR INVENTION

With reference to the accompanying drawings, embodiments of the present application will be described in detail as follows such that those skilled in the art to which the present application pertains may easily practice the present application.

However, the present application may be implemented in various different forms, and is not limited to the embodiments described herein. And, in order to clearly describe the present application in the drawings, parts irrelevant to the description may be omitted, and similar reference numerals may be attached to similar parts throughout the specification.

Throughout present specification, when a part is said to be “connected” to another part, this may include not only the case of being “directly connected” but also the case of being “electrically connected” with another element interposed therebetween.

Throughout present specification, when a member is referred to as being “on,” “at the upper portion of,” “at the top of,” “under,” “at the lower portion of,” or “at the bottom of” another member, this may include not only the case where a member is in contact with another member, but also the case where another member exists between two members.

Throughout present specification, when any part is said to “include” a certain component, this means that the part may further include other components rather than excluding the other components, unless otherwise particularly specified.

As used herein, the terms “about,” “substantially,” and the like may be used in a sense at or close to that number when manufacturing and material tolerances inherent in the stated meaning are given, and may be also used to prevent unfair use by unscrupulous infringers of disclosures in which exact or absolute figures are stated to aid in the understanding of the present application. In addition, throughout the present specification, “steps of doing” or “steps of” may not mean “steps for.”

Throughout the present specification, the term “combination thereof” included in the expression of the Markush form may means one or more mixtures or combinations selected from the group consisting of the components described in the expression of the Markush form, and may mean including one or more selected from the group consisting of the components.

Throughout present specification, reference to “A and/or B” may mean “A or B, or A and B.”

Hereinafter, the quantum dot of the present application and the method for preparing the same may be described in detail with reference to embodiments and examples and drawings. However, the present application is not limited to these embodiments and examples and drawings.

As a technical solution for achieving the above technical objects, a first aspect of the present application may provide a quantum dot including: a core bearing III-V group compounds; and a ligand formed on the core, in which the core is doped with zinc (Zn).

According to one embodiment of the present application, the quantum dot may have P-type semiconductor properties, but is not limited thereto.

While the conventional p-type quantum dots have a disadvantage of causing an environmental problem because of using Cd, which is a toxic material, the quantum dots according to the present application can be p-type quantum dots prepared by using Zn, which is not toxic, thus causing no environmental problem.

In addition, unlike the related art in which the p-type quantum dots are prepared through a rather complicated process because doping is performed through a post-treatment process, the quantum dots according to the present application can have an advantage of being simply prepared through a single synthesis without a post-treatment process.

In addition, in the quantum dots according to the present application, a doping degree of the quantum dots can be controlled according to a content of Zn, and thus a Fermi level and a hole density can be controlled.

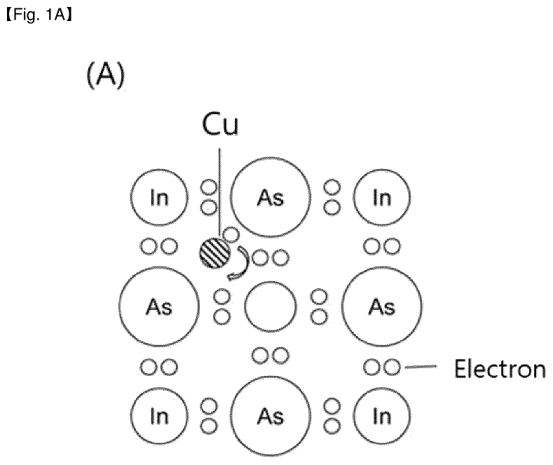

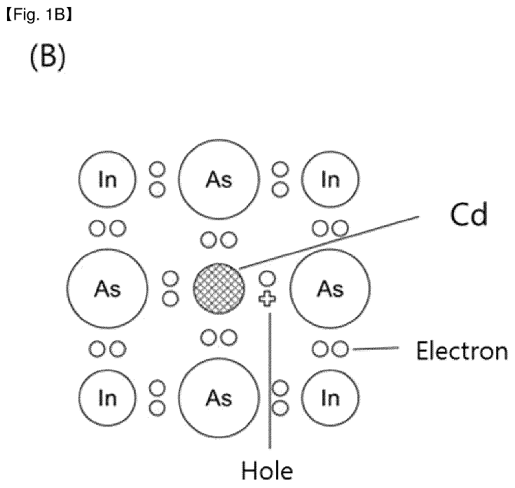

FIG. 1A shows a schematic view of a conventional interstitial-doped quantum dot, and FIG. 1B shows a schematic view of a conventional substitutional-doped quantum dot.

Referring to FIG. 1A, it can be confirmed that interstitial doping of Cu is performed. Interstitial doping may be performed in the form of introducing a dopant between crystal lattices. Cu is introduced between InAs quantum dot lattices and provides additional electrons to act as an n-dopant.

Referring to FIG. 1B, Cd may be doped into the InAs quantum dots through substitutional doping. Unlike In providing three electrons, Cd provides two electrons, and thus acts as a p-dopant by providing one hole.

In the conventional InAs quantum dot, the InAs quantum dot, which was n-type, has been strengthened in n-type properties by Cu and has changed into p-type by Cd. This has been a meaningful result that p-type InAs quantum dots may be obtained through Cd doping, but doping is performed through a subsequent treatment process, and thus it is somewhat complicated, and a toxic heavy metal called Cd is used, thus causing environmental problems.

On the contrary, the quantum dot according to the present application may be a p-type quantum dot prepared by using Zn, which is a relatively eco-friendly material compared to Cd, and thus have an advantage that it may not cause no environmental problem and may be simply prepared through a single synthesis without a subsequent treatment process.

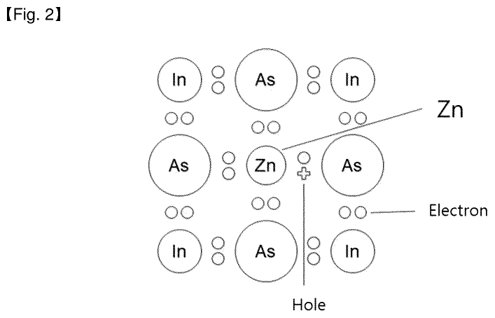

FIG. 2 shows a schematic view of p-type doping of a quantum dot according to one embodiment of the present application.

Referring to FIG. 2, it can be confirmed that Zn is substitutional-doped into InAs, and Zn may provide two electrons like Cd, and thus it can be confirmed that Zn is substituted at the position of In to serve as a p-dopant by generating one hole.

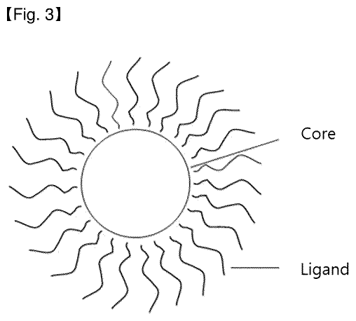

FIG. 3 shows a schematic view of a quantum dot according to one embodiment of the present application.

Referring to FIG. 3, it can be confirmed that the quantum dot according to the present application is composed of a core including III-V group compounds; and a ligand formed on the core.

According to one embodiment of the present application, the III-V group compounds may be selected from the group consisting of indium arsenide (InAs), indium phosphorus (InP), indium antimony (InSb), indium nitride (InN), gallium phosphorus (GaP), gallium arsenide (GaAs), gallium antimony (GaSb), gallium nitride (GaN), aluminum phosphorus (AlP), aluminum arsenide (AlAs), aluminum antimony (AlSb), aluminum nitride (AlN), gallium phosphorus arsenide (GaPAs), gallium phosphorus antimony (GaPSb), gallium phosphorus nitride (GaPN), gallium arsenide nitride (GaAsN), gallium antimony nitride (GaSbN), aluminum phosphorus arsenide (AlPAs), aluminum phosphorus antimony (AlPSb), aluminum phosphorus nitride (AlPN), aluminum arsenide nitride (AlAsN), aluminum antimony nitride (AlSbN), indium phosphorus arsenide (InPAs), indium phosphorus antimony (InPSb), indium phosphorus nitride (InPN), indium arsenide nitride (InAsN), indium antimony nitride (InSbN), aluminum gallium phosphorus (AlGaP), aluminum gallium arsenide (AlGaAs), aluminum gallium antimony (AlGaSb), aluminum gallium nitride (AlGaN), aluminum arsenide nitride (AlAsN), aluminum antimony nitride (AlSbN), indium gallium phosphorus (InGaP), indium gallium arsenide (InGaAs), indium gallium antimony (InGaSb), indium gallium nitride (InGaN), indium arsenide nitride (InAsN), indium antimony nitride (InSbN), aluminum indium phosphorus (AlInP), aluminum indium arsenide (AlInAs), aluminum indium antimony (AlInSb), aluminum indium nitride (AlInN), aluminum arsenide nitride (AlAsN), aluminum antimony nitride (AlSbN), aluminum phosphorus nitride (AlPN), gallium aluminum phosphorus arsenide (GaAlPAs), gallium aluminum phosphorus antimony (GaAlPSb), gallium indium phosphorus arsenide (GaInPAs), gallium indium aluminum arsenide (GaInAlAs), gallium aluminum phosphorus nitride (GaAlPN), gallium aluminum arsenide nitride (GaAlAsN), gallium aluminum antimony nitride (GaAlSbN), gallium indium phosphorus nitride (GaInPN), gallium indium arsenide nitride (GaInAsN), gallium indium aluminum nitride (GaInAlN), gallium antimony phosphorus nitride (GaSbPN), gallium arsenide phosphorus nitride (GaAsPN), gallium arsenide antimony nitride (GaAsSbN), gallium indium phosphorus antimony (GaInPSb), gallium indium phosphorus nitride (GaInPN), gallium indium antimony nitride (GaInSbN), gallium phosphorus antimony nitride (GaPSbN), indium aluminum phosphorus arsenide (InAlPAs), indium aluminum phosphorus nitride (InAlPN), indium phosphorus arsenide nitride (InPAsN), indium aluminum antimony nitride (InAlSbN), indium phosphorus antimony nitride (InPSbN), indium arsenide antimony nitride (InAsSbN), indium aluminum phosphorus antimony (InAlPSb), and combinations thereof, but are not limited thereto.

For example, the III-V group compound may be indium arsenide (InAs), but is not limited thereto.

According to one embodiment of the present application, the ligand may be selected from the group consisting of oleylamine, butylamine, octylamine, dodecylamine, hexadecylamine, hexylamine, propylamine, aniline, benzylamine, octadecylamine, and combinations thereof, but is not limited thereto.

For example, the ligand may be oleylamine, but is not limited thereto.

According to one embodiment of the present application, a diameter of the quantum dot may be 1 nm to 9.5 nm, but is not limited thereto.

The quantum dot according to the present application may be adjusted to have a uniform size in the range of about 1 nm to 9.5 nm, and thus may be industrially useful in various fields such as solar cells, photoelectric conversion elements such as light emitting diodes, next-generation high-brightness LEDs, biosensors, lasers, and the like.

In addition, the quantum dot according to the present application may have excellent electrical and optical properties by having surface defects removed while providing properties of having a uniform particle size distribution, and thus can be usefully applied to electronic elements in various fields such as solar cells, photoelectric conversion elements such as light emitting diodes, next generation high brightness LEDs, biosensors, lasers, and the like.

In addition, a second aspect of the present application may provide a method for preparing a quantum dot, the method comprising: preparing a solution containing a III group precursor and a solvent; reducing a V group precursor by using a compound containing zinc (Zn); and preparing III-V group compounds by mixing the solution and the reduced V group precursor, in which the zinc (Zn) is doped into the III-V group compounds.

With respect to the method for preparing the quantum dot according to a second aspect of the present application, detailed descriptions of parts overlapping with the first aspect of the present application have been omitted, but even if the description is omitted, the contents described in the first aspect of the present application may be applied to the third aspect of the present application.

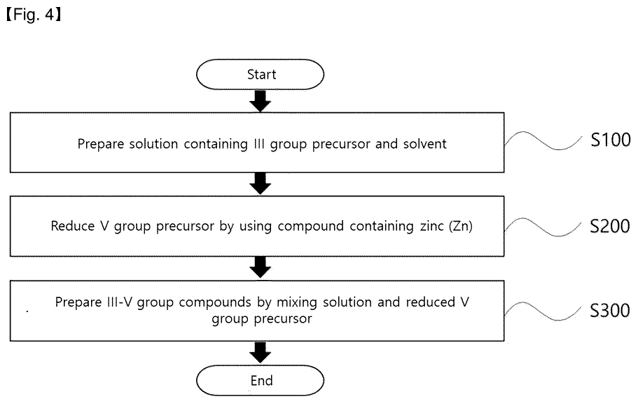

FIG. 4 shows a flow chart of a method for preparing a quantum dot according to one embodiment of the present application.

First, a solution containing a III group precursor and a solvent may be provided (S100).

According to one embodiment of the present application, a III group element of the III group precursor may be selected from the group consisting of indium, aluminum, gallium, and combinations thereof, but is not limited thereto.

For example, a III group element of the III group precursor may be indium, but is not limited thereto.

According to one embodiment of the present application, the III group precursor may be selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium oxide, gallium iodide, triethyl gallium, trimethyl gallium, and combinations thereof, but is not limited thereto.

For example, the III group precursor may be indium chloride, but is not limited thereto.

Indium chloride may be relatively inexpensive and easy to handle among indium halide precursors, and thus preparation costs may be reduced when the indium chloride is used as the III group precursor.

According to one embodiment of the present application, the solvent may be selected from the group consisting of oleylamine, butylamine, octylamine, dodecylamine, hexadecylamine, hexylamine, propylamine, aniline, benzylamine, octadecylamine, and combinations thereof, but is not limited thereto.

For example, the solvent may be oleylamine, but is not limited thereto.

In the case of a secondary amine and a tertiary amine, precursor synthesis may not be possible, and thus the solvent may include a primary amine. Of primary amines, oleylamine may have a highest boiling point and thus a temperature may be variously adjusted.

Then, a V group precursor may be reduced by using a compound containing zinc (Zn) (S200).

In the case of a conventional method for preparing III-V quantum dots, a reducing agent having a strong reducing power is used to reduce a V group compound having low reactivity, thus causing a problem in that it is difficult to control an intermediate step or grow into a sufficient size due to high reactivity, but in the case of the method for preparing quantum dots according to the present application, a compound containing zinc having relatively low reactivity may be used to synthesize a novel intermediate (a reduced V group precursor) having reactivity controlled through a ligand exchange reaction, thereby controlling the intermediate step of quantum dot synthesis. Thus, a size of III-V quantum dots may be stably controlled according to a temperature range, thereby uniformly and sufficiently growing.

For example, an alkyl group of the compound may replace an amine-V bond of dimethylaminoarsine, which is a V group precursor, to be described later and reduce a V group compound to improve the reactivity of arsine and induce to participate in the reaction. The reduced arsine may be used in various forms and may be directly used as a reactant precursor or used as a precursor for growing a pre-synthesized quantum dot.

In the method for preparing quantum dots according to the present application, a reducing agent containing zinc may be used, so that the zinc may remove and stabilize defects on a surface of quantum dots. Accordingly, a quantum dot having improved electrical and optical properties may be prepared by removing surface defects. In addition, the zinc (Zn) may be substitutional-doped into the III-V group compounds, and thus may serve as a p-dopant.

According to one embodiment of the present application, the compound containing zinc (Zn) may be selected from the group consisting of diethyl zinc, dimethyl zinc, diphenyl zinc, di-n-propyl zinc, di-n-butyl zinc, diisobutyl zinc, di-n-pentyl zinc, di-n-hexyl zinc, dicyclohexyl zinc, and combinations thereof, but is not limited thereto.

For example, the compound may be diethyl zinc, but is not limited thereto.

Diethyl zinc may be relatively inexpensive and easy to supply and demand, and thus convenience and economic feasibility thereof may be excellent when diethyl zinc is used as the compound.

According to one embodiment of the present application, a V group element of the V group precursor may be selected from the group consisting of arsenic (As), nitrogen (N), phosphorus (P), and combinations thereof, but is not limited thereto.

For example, a V group element of the V group precursor may be arsenic (As), but is not limited thereto.

According to one embodiment of the present application, the V group precursor may be selected from the group consisting of dimethylaminoarsine, arsenic oxide, arsenic chloride, arsenic sulfate, arsenic bromide, arsenic iodide, tristrimethylsilylarsenide, arsenic trioxide, arsenic silylamide, alkyl phosphine, tristrialkylsilyl phosphine, trisdialkylsilyl phosphine, trisdialkylamino phosphine, nitric oxide, nitric acid, ammonium nitrate, and combinations thereof, but is not limited thereto.

For example, the V group precursor may be dimethylaminoarsine, but is not limited thereto.

The dimethylaminoarsine may be known as a compound with low reactivity. Thus, a reducing agent having a strong reducing power may be used for reduction, thus causing a problem in that it is difficult to control an intermediate step or grow into a sufficient size due to high reactivity.

For example, in the method for preparing quantum dots according to the present application, an alkyl group of diethyl zinc may replace an amine-V bond of dimethylaminoarsine and reduce dimethylaminoarsine to improve the reactivity of arsine and induce to participate in the reaction. The reduced arsine may be used in various forms and may be directly used as a reactant precursor or used as a precursor for growing a pre-synthesized quantum dot.

For example, the reducing agent may be a reducing agent including zinc (Zn). More specifically, for example, the reducing agent may be selected from the group consisting of dimethylzinc, diethylzinc, diisopropylzinc, and combinations thereof, but is not limited thereto.

Then, III-V group compounds may be prepared by mixing the solution and the reduced V group precursor (S300).

As described above, a conventional method for preparing quantum dots having p-type semiconductor properties has a disadvantage of causing an environmental problem in that a quantum dot is prepared by using Cd, which is a toxic material, and a preparation process is complicated because a subsequent processing process needs to be performed.

However, in the method for preparing quantum dots according to the present application, zinc (Zn) of the zinc-containing compound used in the reducing of the V group V precursor (S200) may be substitutional-doped into the III-V group compounds to serve as a p-dopant. Accordingly, it may be possible to prepare quantum dots having p-type semiconductor properties through a simple process which does not use a toxic material and does not require a subsequent treatment process.

According to the quantum dot preparation method of the present application, the ratio of Zn to the III group precursor may be controlled.

Accordingly, a current-voltage property of an electronic element including the quantum dots prepared through the quantum dot preparation method may be controlled.

Specifically, according to the quantum dot preparation method according to one exemplary embodiment of the present application, the ratio of Zn to the III group precursor may be controlled to increase.

Accordingly, an electronic element including the quantum dots prepared through the quantum dot preparation method may have p-type semiconductor properties.

Alternatively, according to the quantum dot preparation method according to one exemplary embodiment of the present application, the ratio of the III group precursor to Zn may be controlled to increase.

Accordingly, an electronic element including the quantum dots prepared through the quantum dot preparation method may have n-type semiconductor properties.

Alternatively, according to the quantum dot preparation method according to one exemplary embodiment of the present application, the ratios of the III group precursor and Zn may be controlled to be substantially the same.

Accordingly, an electronic element including the quantum dots prepared through the quantum dot preparation method may have ambipolar semiconductor properties.

According to one embodiment of the present application, the mixing may be performed in a temperature range of 1 to 350° C., but is not limited thereto.

According to one embodiment of the present application, a diameter of the quantum dot may be adjusted depending on the temperature range, but is not limited thereto.

The preparing of III-V group compounds by mixing the solution and the reduced V group precursor may include mixing the solution and a novel intermediate (reduced group V precursor) with reactivity controlled and reacting the resulting mixture to prepare quantum dots. For example, the mixing may be performed at room temperature. When the reacting after mixing is performed at about 160° C., a quantum dot having a diameter of about 1.6 nm may be prepared, when the reacting is performed at about 200° C., a quantum dot having a diameter of about 2.0 nm may be prepared, and when the reacting is performed at about 240° C., a quantum dot having a diameter of about 2.4 nm may be prepared.

In addition, in the method for preparing quantum dots according to the present application, an intermediate step of quantum dot synthesis may be controlled to diversity a synthesis method.

Thus, the method for preparing quantum dots according to the present application may not be limited to one synthesis method, but may be applied to all methods such as slow injection, hot injection, heat up, and the like, which are known as existing synthesis methods.

In addition, a third aspect of the present application may provide an electronic element including a quantum dot according to a first aspect of the present application.

With respect to the electronic element according to the third aspect of the present application, detailed descriptions of parts overlapping with the first and/or second aspects of the present application have been omitted, but even if the description is omitted, the contents described in the first and/or second aspects of the present application may be applied to the third aspect of the present application.

The quantum dot according to the present application may have excellent electrical and optical properties by having surface defects removed while providing properties of having a uniform particle size distribution, and thus can be usefully applied to electronic elements in various fields such as solar cells, photoelectric conversion elements such as light emitting diodes, next generation high brightness LEDs, biosensors, lasers, and the like.

The above-described technical solutions are set forth to illustrate only and should not be construed as intended to limit the present disclosure. In addition to the exemplary embodiments described above, additional embodiments may exist in the drawings and detailed description of the invention.

Hereinafter, the present invention will be described in more detail through the following examples, but the following examples are for illustrative purposes only and are not intended to limit the scope of the present application.

### [Example] Preparation of Quantum Dot (Indium Arsenide (InAs))

0.5 mmol of indium chloride and 8 mL of oleylamine were reacted at 120° C. to form a solution containing an indium oleate precursor.

Then, 0.7 ml of oleylamine, 0.3 mmol of dimethylaminoarsine, and 0.6 mmol of diethyl zinc were reacted at 240° C. for 10 to 60 minutes to reduce dimethylaminoarsine, thereby synthesizing an intermediate.

Subsequently, the solution and the reduced dimethylaminoarsine (intermediate) were mixed and heated to prepare an InAs quantum dot doped with zinc having p-type semiconductor properties.

### Experimental Example 1

A thin film transistor (TFT) was manufactured by using the quantum dots prepared in the above Example. The TFT was fabricated by depositing Cr and Au on a wafer composed of p++ Si and SiO₂. Here, a quantum dot thin film according to an example was formed through spin-coating.

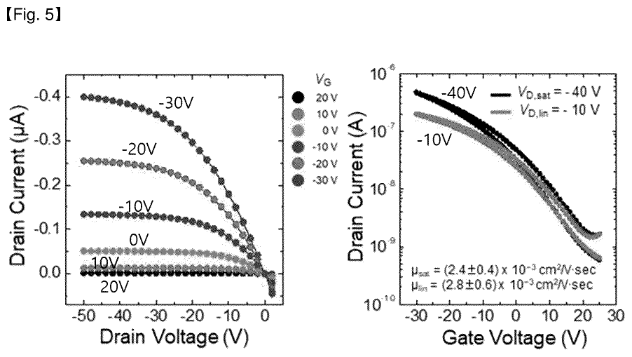

FIG. 5 shows a graph obtained by measuring element properties of TFT including a quantum dot according to one example of the present application.

Referring to FIG. 5, it can be confirmed that p-type properties are clearly shown as a result of measuring the TFT element.

### Experimental Example 2

In above Example, a thin film transistor (TFT) was manufactured by using the quantum dots prepared with 0.2 mmol of diethylzinc. The TFT was fabricated by depositing Cr and Au on a wafer composed of p++ Si and SiO₂. Here, a quantum dot thin film according to an example was formed through spin-coating.

### Experimental Example 3

In above Example, a thin film transistor (TFT) was manufactured by using the quantum dots prepared with 0.4 mmol of diethylzinc. The TFT was fabricated by depositing Cr and Au on a wafer composed of p++ Si and SiO₂. Here, a quantum dot thin film according to an example was formed through spin-coating.

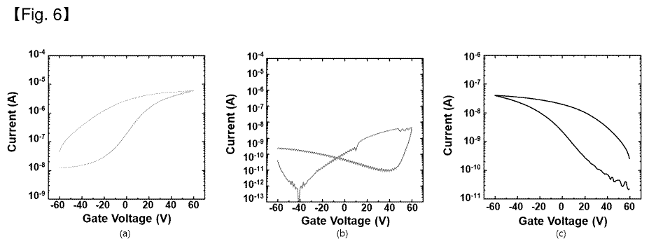

FIG. 6 shows a current-voltage curve of TFT including quantum dots according to Experimental Examples 1 to 3 of the present application, respectively.

Referring to (a) of FIG. 6, it can be confirmed that TFT manufactured with quantum dots including a smallest amount of diethylzinc according to above Experimental Example 2 may have n-type properties.

Meanwhile, referring to (b) of FIG. 6, it can be confirmed that TFT manufactured according to above Experimental Example 3 with quantum dots having an amount of diethylzinc increased as compared to above Experimental Example 2 may have ambipolar properties.

On the contrary, referring to (c) of FIG. 6, it can be confirmed that TFT manufactured with quantum dots including a largest amount of diethylzinc according to above Experimental Example 1 may have p-type properties.

Thus, according to the method for preparing quantum dots of the present application, it can be proved that a current-voltage property of an electronic element including quantum dots to be prepared may be controlled by controlling the ratio of Zn to the III group precursor.

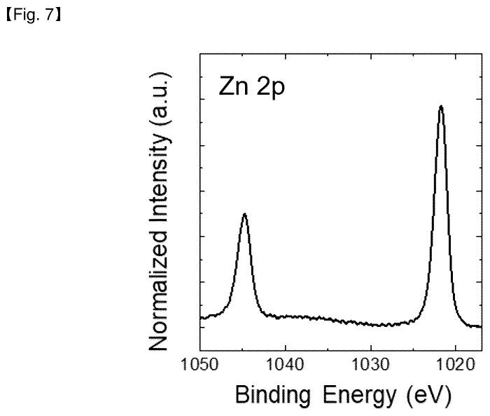

FIG. 7 shows a result of x-ray photoelectron spectroscopy (XPS) measurement of a quantum dot according to an example of the present application.

Referring to FIG. 7, a zinc (Zn) 2p spectrum can be confirmed from the quantum dot according to an example of the present application. More specifically, it can be seen that the quantum dot according to an example of the present application has a binding energy peak of 1,020 or more to 1,030 or less and 1,040 or more to 1,050 or less.

Accordingly, it can be seen that the quantum dot according to an example of the present application is doped with zinc (Zn).

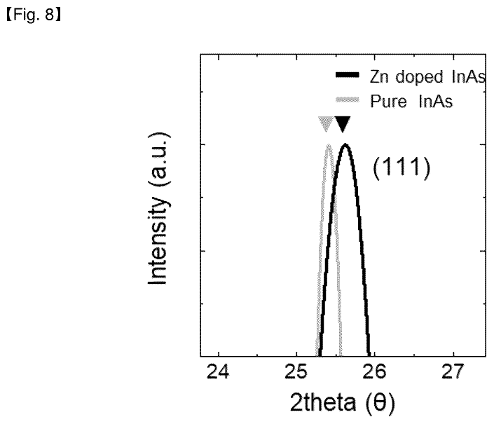

FIG. 8 shows a result of x-ray diffraction (XRD) measurement of a quantum dot according to an example of the present application and a conventional quantum dot.

Referring to FIG. 8, it can be seen that a (111) peak of quantum dot (Zn doped InAs) according to an example of the present application is observed at 2 theta which is higher than that of the conventional quantum dot (Pure InAs). More specifically, it can be seen that the conventional quantum dot (Pure InAs) has a (111) peak at 2 theta of 25 or more to less than 25.5, but the quantum dot (Zn doped InAs) according to an example of the present application has a (111) peak at 2 theta of 25.5 or more to 26.5 or less.

Referring to FIG. 2, this may be because in an example of the present application, zinc (Zn) is doped to introduce zinc (Zn) having a relatively small diameter at an indium (In) site in an indium arsenide (InAs) quantum dot lattice and a lattice constant is reduced.

Accordingly, it can be proven that the quantum dot according to an example of the present application is doped with zinc (Zn).

The above description of the present application is for illustrative purposes, and those skilled in the art will understand that it can be easily modified into other specific forms without changing the technical spirit or essential features of the present application. Therefore, the embodiments described above should be understood as illustrative in all respects and not limiting. For example, each component described as a single type may be implemented in a distributed manner, and similarly, components described as distributed may be implemented in a combined form.

The scope of the present application is indicated by the following claims rather than the detailed description above, and all changes or modifications derived from the meaning and scope of the claims and equivalent concepts thereof should be construed as being included in the scope of the present application.

1. A quantum dot comprising:
a core bearing III-V group compounds; and
a ligand formed on the core, wherein the core is doped with zinc (Zn).

2. The quantum dot of claim 1, wherein the quantum dot has p-type semiconductor properties.

3. The quantum dot of claim 1, wherein the III-V group compounds are selected from the group consisting of indium arsenide (InAs), indium phosphorus (InP), indium antimony (InSb), indium nitride (InN), gallium phosphorus (GaP), gallium arsenide (GaAs), gallium antimony (GaSb), gallium nitride (GaN), aluminum phosphorus (AlP), aluminum arsenide (AlAs), aluminum antimony (AlSb), aluminum nitride (AlN), gallium phosphorus arsenide (GaPAs), gallium phosphorus antimony (GaPSb), gallium phosphorus nitride (GaPN), gallium arsenide nitride (GaAsN), gallium antimony nitride (GaSbN), aluminum phosphorus arsenide (AlPAs), aluminum phosphorus antimony (AlPSb), aluminum phosphorus nitride (AlPN), aluminum arsenide nitride (AlAsN), aluminum antimony nitride (AlSbN), indium phosphorus arsenide (InPAs), indium phosphorus antimony (InPSb), indium phosphorus nitride (InPN), indium arsenide nitride (InAsN), indium antimony nitride (InSbN), aluminum gallium phosphorus (AlGaP), aluminum gallium arsenide (AlGaAs), aluminum gallium antimony (AlGaSb), aluminum gallium nitride (AlGaN), aluminum arsenide nitride (AlAsN), aluminum antimony nitride (AlSbN), indium gallium phosphorus (InGaP), indium gallium arsenide (InGaAs), indium gallium antimony (InGaSb), indium gallium nitride (InGaN), indium arsenide nitride (InAsN), indium antimony nitride (InSbN), aluminum indium phosphorus (AlInP), aluminum indium arsenide (AlInAs), aluminum indium antimony (AlInSb), aluminum indium nitride (AlInN), aluminum arsenide nitride (AlAsN), aluminum antimony nitride (AlSbN), aluminum phosphorus nitride (AlPN), gallium aluminum phosphorus arsenide (GaAlPAs), gallium aluminum phosphorus antimony (GaAlPSb), gallium indium phosphorus arsenide (GaInPAs), gallium indium aluminum arsenide (GaInAlAs), gallium aluminum phosphorus nitride (GaAlPN), gallium aluminum arsenide nitride (GaAlAsN), gallium aluminum antimony nitride (GaAlSbN), gallium indium phosphorus nitride (GaInPN), gallium indium arsenide nitride (GaInAsN), gallium indium aluminum nitride (GaInAlN), gallium antimony phosphorus nitride (GaSbPN), gallium arsenide phosphorus nitride (GaAsPN), gallium arsenide antimony nitride (GaAsSbN), gallium indium phosphorus antimony (GaInPSb), gallium indium phosphorus nitride (GaInPN), gallium indium antimony nitride (GaInSbN), gallium phosphorus antimony nitride (GaPSbN), indium aluminum phosphorus arsenide (InAlPAs), indium aluminum phosphorus nitride (InAlPN), indium phosphorus arsenide nitride (InPAsN), indium aluminum antimony nitride (InAlSbN), indium phosphorus antimony nitride (InPSbN), indium arsenide antimony nitride (InAsSbN), indium aluminum phosphorus antimony (InAlPSb), and combinations thereof.

4. The quantum dot of claim 1, wherein the ligand is selected from the group consisting of oleylamine, butylamine, octylamine, dodecylamine, hexadecylamine, hexylamine, propylamine, aniline, benzylamine, octadecylamine, and combinations thereof.

5. The quantum dot of claim 1, wherein a diameter of the quantum dot is 1 nm to 34 nm.

6. A method for preparing a quantum dot, the method comprising:
preparing a solution containing a III group precursor and a solvent;
reducing a V group precursor by using a compound containing zinc (Zn); and
preparing III-V group compounds by mixing the solution and the reduced V group precursor, wherein the zinc (Zn) is doped into the III-V group compounds.

7. The method of claim 6, wherein the mixing is performed in a temperature range of 1 to 350° C.

8. The method of claim 7, wherein a diameter of the quantum dot is adjusted depending on the temperature range.

9. The method of claim 6, wherein a III group element of the III group precursor is selected from the group consisting of indium, aluminum, gallium, and combinations thereof.

10. The method of claim 6, wherein the III group precursor is selected from the group consisting of indium chloride, indium iodide, indium chloride tetrahydrate, indium oxide, indium nitrate, indium nitrate hydrate, indium sulfate, indium sulfate hydrate, indium acetate, indium acetylacetonate, indium bromide, indium fluoride, indium fluoride trihydrate, trimethyl indium, indium oleate, indium carboxylate, aluminum acetate, aluminum iodide, aluminum bromide, aluminum chloride, aluminum chloride hexahydrate, aluminum fluoride, aluminum nitrate, aluminum oxide, aluminum perchlorate, aluminum carbide, aluminum stearate, aluminum sulfate, di-i-butylaluminum chloride, diethylaluminum chloride, tri-i-butylaluminum, triethylaluminum, triethyl(tri-sec-butoxy)dialuminum, aluminum phosphate, aluminum acetylacetonate, trimethylaluminum, gallium acetylacetonate, gallium chloride, gallium fluoride, gallium fluoride trihydrate, gallium oxide, gallium nitrate, gallium nitrate hydrate, gallium sulfate, gallium oxide, gallium iodide, triethyl gallium, trimethyl gallium, and combinations thereof.

11. The method of claim 6, wherein the solvent is selected from the group consisting of oleylamine, butylamine, octylamine, dodecylamine, hexadecylamine, hexylamine, propylamine, aniline, benzylamine, octadecylamine, and combinations thereof.

12. The method of claim 6, wherein the compound containing zinc (Zn) is selected from the group consisting of diethyl zinc, dimethyl zinc, diphenyl zinc, di-n-propyl zinc, di-n-butyl zinc, diisobutyl zinc, di-n-pentyl zinc, di-n-hexyl zinc, dicyclohexyl zinc, and combinations thereof.

13. The method of claim 6, wherein a V group element of the V group precursor is selected from the group consisting of arsenic (As), nitrogen (N), phosphorus (P), and combinations thereof.

14. The method of claim 6, wherein the V group precursor is selected from the group consisting of dimethylaminoarsine, arsenic oxide, arsenic chloride, arsenic sulfate, arsenic bromide, arsenic iodide, tristrimethylsilylarsenide, arsenic trioxide, arsenic silylamide, alkyl phosphine, tristrialkylsilyl phosphine, trisdialkylsilyl phosphine, trisdialkylamino phosphine, nitric oxide, nitric acid, ammonium nitrate, and combinations thereof.

15. The method of claim 6, wherein a ratio of Zn to the III group precursor is controlled by controlling a mixing amount of the solution and the reduced V group precursor.

16. The method of claim 15, wherein a ratio of Zn to the III group precursor is greatly controlled, thus resulting in p-type semiconductor properties.

17. A quantum dot comprising III-V group compounds, wherein the quantum dot has a 2 theta peak of 25.5 or more to 26.5 or less in x-ray diffraction (XRD).

18. The quantum dot of claim 17, wherein the peak has a (111) crystal orientation.

19. The quantum dot of claim 17, wherein the quantum dot has a binding energy peak of 1,020 or more to 1,030 or less and 1,040 or more to 1,050 or less in x-ray photoelectron spectroscopy (XPS).

20. An electronic element comprising a quantum dot according to claim 1.

21. An electronic element comprising a quantum dot according to claim 2.

22. An electronic element comprising a quantum dot according to claim 3.

23. An electronic element comprising a quantum dot according to claim 4.

24. An electronic element comprising a quantum dot according to claim 5.
